(19) United States
(12) Patent Application Publication
(10) Pub. No.: US 2009/0094420 A1
(43) Pub. Date: Apr. 9, 2009

(54) DATA ACCESS METHOD AND MEMORY USING THE SAME

(75) Inventor: Cheng-Wen Chang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Novatek Microelectronics Corp., Hsinchu (TW)

(21) Appl. No.: 11/962,125

(22) Filed: Dec. 21, 2007

(30) Foreign Application Priority Data
Oct. 4, 2007 (TW) 96137243

(51) Int. Cl. G06F 12/00

(52) U.S. Cl. 711/154; 711/E12.001

(57) ABSTRACT

A data access method and a memory using the same are provided in the present invention. In the data access method, a central processing unit (CPU) write command and a display read command are directly input to a memory in order to optimize the operation time.

### CROSS-REFERENCE TO RELATED APPLICATION

This application claims the priority benefit of Taiwan application serial no. 96137243, filed on Oct. 4, 2007. The entirety of the above-mentioned patent application is hereby incorporated by reference herein and made a part of this specification.

### BACKGROUND OF THE INVENTION

1. Field of the Invention

The present invention generally relates to a data access method and a unit using the same, in particular, to a data access method and a memory using the same.

2. Description of Related Art

In recent years, liquid crystal display (LCD) has been broadly applied to various information products, such as cell phones, personal digital assistants (PDAs), computer displays, and TVs, due to its characteristics such as low power consumption, no scattering radiation, light weight, and small volume. Besides, large-sized display products having high display quality (for example, high resolution and contrast ratio) have become highly demanded along with the widespread of cell phones, networks, and other digital products. Because high-speed image data processing is essential to such large-sized display products having high display quality, how to increase the speed of image data processing has become one of today's major subjects.

While processing an image data, an external host controls the entire operation through a central processing unit (CPU) interface, a source driver and a LCD panel display the image, and a scanning circuit selects entire rows of pixels according to the addresses thereof and supplies a voltage to the pixels so as to turn on the pixels.

A LCD driver includes various circuits, such as a memory, a CPU interface, and a panel interface etc. The memory receives a CPU write command, a display read command, and the address data thereof through the CPU interface and outputs pixel data to the LCD panel through the panel interface so as to display the image.

FIG. 1 is a diagram illustrating how conventionally a host 11 inputs a CPU write command 111 and a display read command 112 to a memory 13 through an interface 12. The host 11 issues the CPU write command 111, a CPU write address signal 113, a CPU write data signal 114, the display read command 112, and a display read address signal 115, and then a memory write command 121, a memory write address signal 123, a memory write data signal 124, a memory read command 122, and a memory read address signal 125 are transmitted to the memory 13 through a digital control circuit 15 and a high-frequency oscillator 14.

FIG. 2 is a timing diagram of related signals in FIG. 1. The CPU write command 111 and the display read command 112 usually happen closely or at the same time. As shown in FIG. 2, the CPU write command 111 is issued at time point t21, and the display read command 112 is issued at time point t22, wherein time points t21 and t22 are very close to each other. Conventionally, these two commands are separated and allocated with the same operation time by the digital control circuit 15 and the high-frequency oscillator 14. Taking the memory write command 121 and the memory read command 122 separated by the digital control circuit 15 as example, the interval between time points t21 and t24 is the same as the interval between time points t25 and t26, and accordingly the memory will respectively execute foregoing two commands with the same operation time.

However, the actual time spent for executing foregoing two commands may be different. For example, regarding the memory write command 121, the time spent for writing data into the memory may be the interval between time points t21 and t23, while regarding the memory read command 122, the time spent for reading data from the memory may be the interval between time points t25 and t26. Accordingly, the interval between time points t23 and t25 is an idle time between the write operation and the read operation performed to the memory.

As described above, data access time may be wasted in the conventional method for accessing a memory through a digital control circuit and a high-frequency oscillator.

Thereby, a new memory data access method is to be provided in order to reduce the time waste so that the operation time can be optimized and the efficiency in image data processing can be improved.

### SUMMARY OF THE INVENTION

Accordingly, the present invention is directed to a data access method for a memory, wherein the time waste is reduced and the operation time is optimized.

The present invention is directed to a memory having optimized operation time.

The present invention provides a data access method for a memory. In the data access method, a central processing unit (CPU) write command and a display read command are directly input to the memory so that the memory can perform a read operation during the spare time of a write operation.

The present invention provides a memory including an arbitration circuit. When the arbitration circuit receives a CPU write command and a display read command, the write command is first executed to write data into the memory, and one or multiple read operations is performed on the memory by executing the display read command during the spare time of the write operation.

According to an embodiment of the present invention, the read operation can be divided so as to be inserted appropriately into the spare time of the write operation.

The present invention provides an asynchronous memory data access method. According to the method, a read operation is performed during the spare time of a write operation so that the idle time after the write operation has been completed in the conventional technique can be greatly reduced and accordingly the operation time can be optimized.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional memory data access system.

FIG. 2 is a timing diagram of related signals in FIG. 1.

FIG. 3 is a block diagram of an asynchronous memory data access system according to an embodiment of the present invention.

FIG. 4 is a timing diagram of related signals in FIG. 3.

FIG. 5 is a circuit diagram of an asynchronous memory according to an embodiment of the present invention.

FIG. 6 is a timing diagram of related signals when only a CPU write command is input to the asynchronous memory illustrated in FIG. 5.

FIG. 7 is a timing diagram of related signals when only a display read command is input to the asynchronous memory illustrated in FIG. 5.

FIG. 8 is a timing diagram of related signals when the asynchronous memory illustrated in FIG. 5 receives a CPU write command before a display read command.

FIG. 9 is a timing diagram of related signals when the asynchronous memory illustrated in FIG. 5 receives a display read command before a CPU write command.

FIG. 10 is a timing diagram illustrating the relationship between operation time allocated to read operation and the CPU write cycle regarding the asynchronous memory illustrated in FIG. 5.

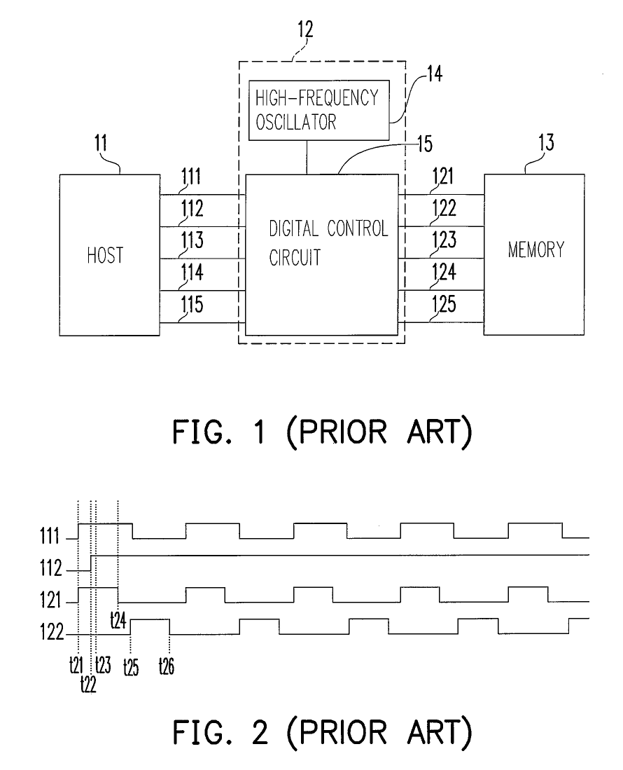

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention will be described with reference to accompanying drawings.

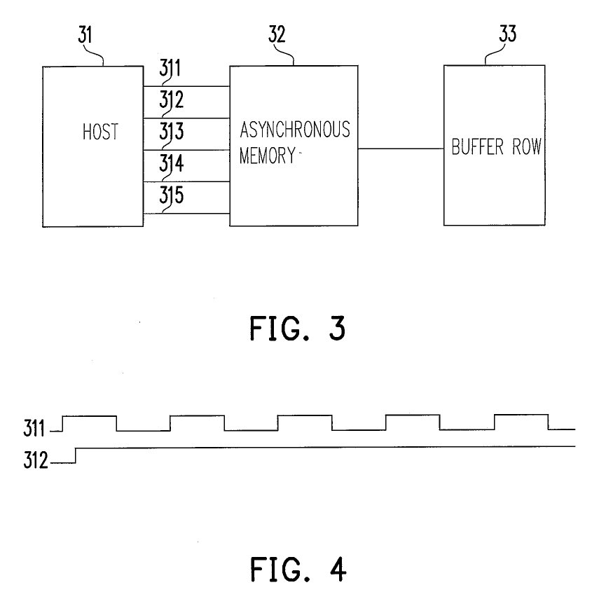

FIG. 3 is a block diagram of an asynchronous memory data access system according to an embodiment of the present invention. The CPU write command 311 is executed for writing a pixel data (for example, of 18 bits, depending on the number of gray scales), and the display read command 312 is executed for reading entire row of pixel data from the memory. Namely, if the memory has a size of 320*240 (i.e. the memory has 320*240 pixels), 240 pixel data is to be read continuously.

The asynchronous memory 32 asynchronously arbitrates between the CPU write command 311 and the display read command 312 with the CPU write command 311 prior to the display read command 312, and the asynchronous memory 32 performs a plurality of read operations corresponding to the display read command 312 on itself until a buffer row 33 is full. Since the CPU write command 311 is prior to the display read command 312, these read operations are performed during spare time of the write operation.

As shown in FIG. 3, the asynchronous memory 32 receives the CPU write command 311 and the display read command 312 directly from the host 31, wherein the CPU write command 311 contains a CPU write address signal 313 and a CPU write data signal 314, and the display read command 312 contains a display read address signal 315. The asynchronous memory 32 outputs to a buffer row 33. FIG. 4 is a timing diagram of the CPU write command 311 and display read command 312 in FIG. 3.

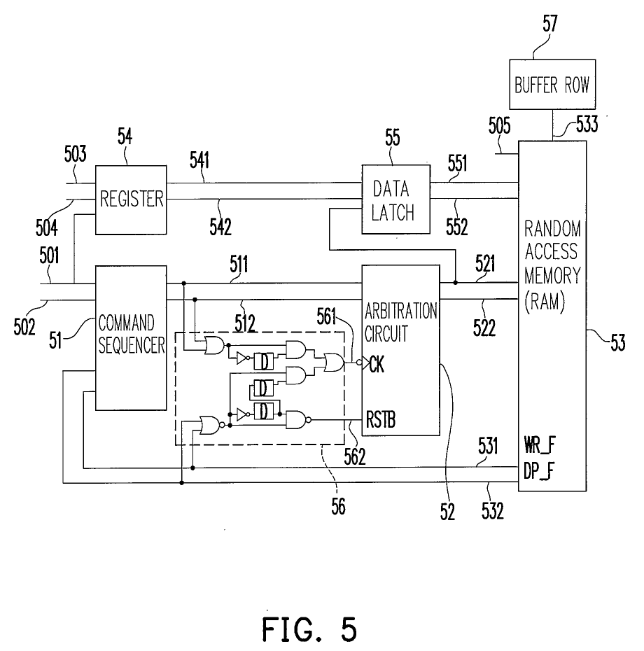

FIG. 5 is a circuit diagram of an asynchronous memory according to an embodiment of the present invention. In the present embodiment, the asynchronous memory can directly process signals received from a host therefore the high-frequency oscillator and digital control circuit adopted in the conventional technique can be skipped.

A read operation is performed during the spare time of a write operation.

In FIG. 5, the display read command 502 is issued to request the asynchronous memory to read an entire row of pixels into a buffer row 57. However, since the quantity of data to be read is too large and accordingly unstable voltage may be caused, the read operation has to be divided. Thus, the asynchronous memory performs a plurality of read operations on itself and transmits the pixel data to the buffer row 57 through a data bus 533 until the buffer row 57 is full. For the convenience of description, it is always assumed in following embodiments that two read operations are performed.

Below, some possible situations of the present embodiment will be explained in detail.

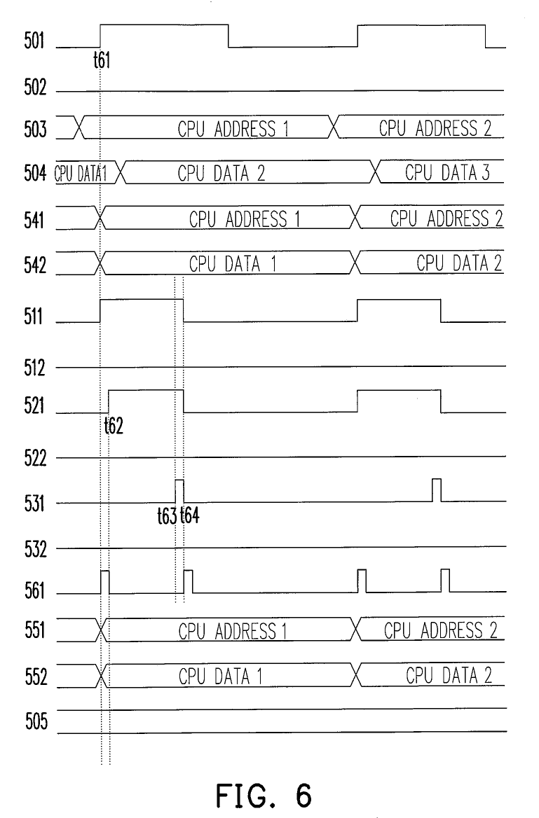

FIG. 6 is a timing diagram of related signals when only a CPU write command is input to the asynchronous memory illustrated in FIG. 5. Referring to FIG. 5 and FIG. 6, when the CPU write operation is to be performed, first, the host issues a CPU write command 501 at time point t61. A register 54 registers a CPU write data signal 504 and a CPU write address signal 503 at a positive edge of the CPU write command 501. Meanwhile, a command sequencer 51 pulls a memory write state signal 511 up to a high level at time point t61, as shown in FIG. 6. After that, at time point t62, an arbitration circuit 52 pulls a memory write signal 521 up to a high level so that the data latch 55 can latch a CPU write data signal 542 and a CPU write address signal 541 received from the register 54. Next, a random access memory (RAM) 53 starts to perform the write operation. At time point t63, the write operation is completed when the CPU write operation completion feedback signal 531 at the write operation feedback terminal (WR_F) transforms from low to high level. At time point t64, when the CPU write operation completion feedback signal 531 transforms from high to low level, the command sequencer 51 clears a previously recorded memory write state signal, the memory write state signal 511 is pulled down to a low level, and a reset terminal RSTB receives a reset signal 562. The arbitration circuit 52 performs a reset operation to set the memory write signal 521 and the memory read signal 522 to a low level, and whether there is still other commands to be executed is then determined by triggering a signal terminal CK at a negative edge of a judgement signal 561. The write operation is completed if there is no other command to be executed.

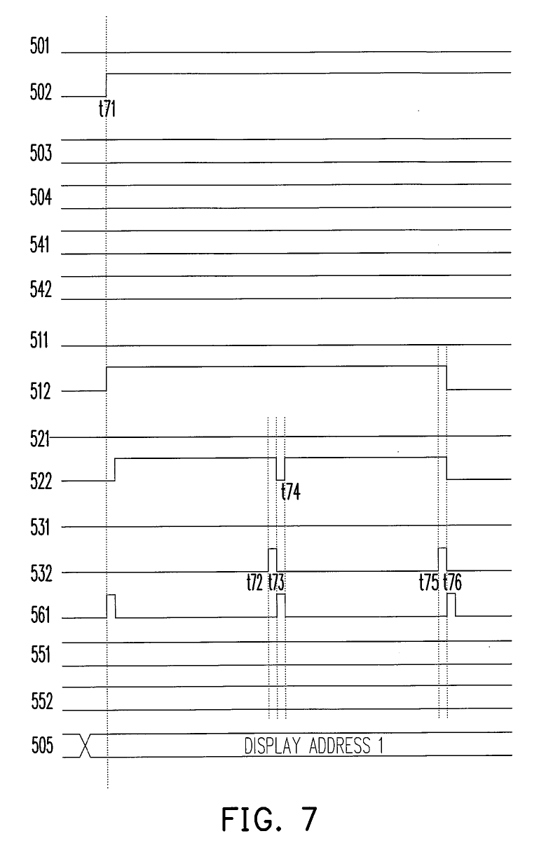

FIG. 7 is a timing diagram of related signals when only a display read command is input to the asynchronous memory illustrated in FIG. 5. Referring to FIG. 5 and FIG. 7, when the display read operation is to be performed, first, the host issues a display read command 502 at time point t71. The command sequencer 51 then pulls the memory read state signal 512 up to a high level. After that, the arbitration circuit 52 pulls the memory read signal 522 up to a high level. Next, the RAM 53 starts to perform the display read operation. At time point t72, the read operation is completed when the display read operation completion feedback signal 532 transforms from low to high level. At time point t73, the display read operation completion feedback signal 532 transforms from high to low level. Since only one read operation is performed, the command sequencer 51 does not clear the previously recorded memory read state signal so that the memory read state signal 512 remains its original level. The arbitration circuit 52 first performs a reset operation in order to set the memory write signal 521 and the memory read signal 522 to a low level. Whether there is still other command to be executed is then determined by triggering the signal terminal CK at a negative edge of the judgement signal 561. Since the memory read state signal 512 is still at a high level, the memory read signal 522 is pulled up to a high level again at time point t74. Next, the RAM 53 executes a second read operation. At time point t75, the read operation is completed when the display read operation completion feedback signal 532 at a read operation feedback terminal (DP_F) transforms from low to high level. At time point t76, the display read operation completion feedback signal 532 transforms from high to low level. Since two read operations have been performed, the command sequencer 51 clears the previously recorded memory read state signal so that the memory read state signal 512 is pulled down to a low level, and the arbitration circuit 52 performs a reset operation to set the memory write signal 521 and the memory read signal 522 to a low level. Whether there is still other command to be executed is then determined by triggering the signal terminal CK at a negative edge of the judgement signal 561. The read operation is completed if there is no other command to be executed.

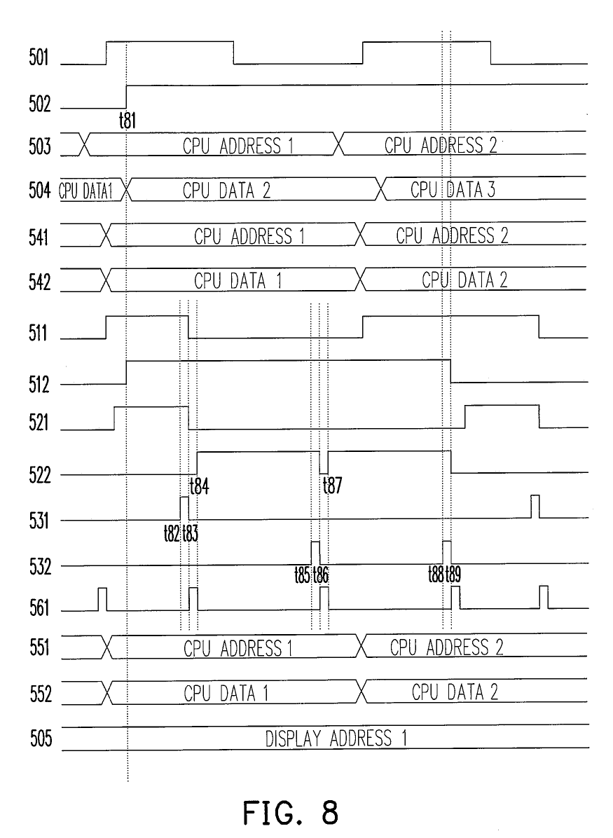

FIG. 8 is a timing diagram of related signals when the asynchronous memory illustrated in FIG. 5 receives a CPU write command before a display read command. As we have assumed, two read operations will be performed once the CPU write operation is completed, namely, a read operation is performed during the spare time between two CPU write operations and after that, the CPU write operation is continued. Referring to FIG. 5 and FIG. 8, at time point t81, the host issues the display read command 502, and the memory read state signal 512 is pulled up to a high level. At time point t82, the write operation is completed when the CPU write operation completion feedback signal 531 transforms from low to high level. At time point t83, when the CPU write operation completion feedback signal 531 transforms from high to low level, the command sequencer 51 clears the previously recorded memory write state signal so that the memory write state signal 511 is pulls down to a low level again. The arbitration circuit 52 performs a reset operation to set the memory write signal 521 and the memory read signal 522 to a low level, and whether there is still other command to be executed is then determined by triggering the signal terminal CK at a negative edge of the judgement signal 561. At time point t84, the arbitration circuit 52 pulls the memory read signal 522 up to a high level. Next, the RAM 53 starts to perform the read operation. At time point t85, the read operation is completed when the display read operation completion feedback signal 532 transforms from low to high level. At time point t86, the display read operation completion feedback signal 532 transforms from high to low level. Since only one read operation is performed, the command sequencer 51 does not clear the previously recorded memory read state signal so that the memory read state signal 512 remains at its original level, and the arbitration circuit 52 performs a reset operation to set the memory write signal 521 and the memory read signal 522 to a low level. Whether there is still other command to be executed is then determined at a negative edge of the judgement signal 561. Since the memory read state signal 512 is still at high level (as shown in FIG. 8), the memory read signal 522 is pulled up to a high level again at time point t87. Then the RAM 53 performs a second read operation. At time point t88, the read operation is completed when the display read operation completion feedback signal 532 transforms from low to high level. At time point t89, when the display read operation completion feedback signal 532 transforms from high to low level, since two read operations have been performed, the command sequencer 51 clears the previously recorded memory read state signal so that the memory read state signal 512 is pulled down to a low level, and the arbitration circuit 52 performs a reset operation to set the memory write signal 521 and the memory read signal 522 to a low level. After that, whether there is still other command to be executed is determined at a negative edge of the judgement signal 561. Since the memory write state signal 511 is at a high level and the memory read state signal 512 is at a low level, the write operation is then performed as described in foregoing embodiment.

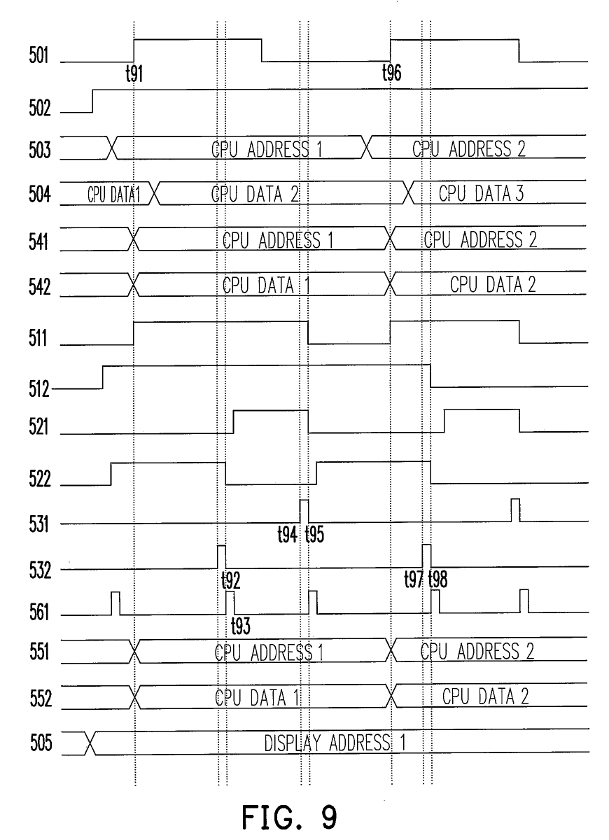

FIG. 9 is a timing diagram of related signals when the asynchronous memory illustrated in FIG. 5 receives a display read command before a CPU write command. As we know, a CPU write operation is performed once a display read operation is completed, and after the write operation is completed, a second read operation is performed, namely, the read operations are performed during spare time of the CPU write operation, and after that, the CPU write operation is continued. Referring to FIG. 5 and FIG. 9, at time point t91, the host issues a CPU write command 501, and so the memory write state signal 511 is pulled up to a high level. The read operation is completed when the display read operation completion feedback signal 532 transforms from low to high level. At time point t92, when the display read operation completion feedback signal 532 transforms from high to low level, the command sequencer 51 does not clear the previously recorded memory read state signal so that the memory read state signal 512 remains at its original level, and the arbitration circuit 52 performs a reset operation to set the memory write signal 521 and the memory read signal 522 to a low level. At time point t93, whether there is still other command to be executed is determined by triggering the signal terminal CK at a negative edge of the judgement signal 561. Here the memory write state signal 511 and the memory read state signal 512 are both at a high level, but because the write operation has higher priority than the read operation, the write operation is then performed as described in foregoing embodiment. At time point t94, the write operation is completed when the CPU write operation completion feedback signal 531 transforms from low to high level. At time point t95, when the CPU write operation completion feedback signal 531 transforms from high to low level, the command sequencer 51 clears the previously recorded memory write state signal so that the memory write state signal 511 is pulled down to a low level. After that, the arbitration circuit 52 performs a reset operation to set the memory write signal 521 and the memory read signal 522 to a low level. Next, whether there is still other command to be executed is determined at a negative edge of the judgement signal 561. Since the memory write state signal 511 is at a low level and the memory read state signal 512 is at a high level, the read operation is then performed as described in foregoing embodiment. During this process, the host issues the CPU write command 501 at time point t96, and here the memory write state signal 511 is pulled up to a high level. At time point t97, the read operation is completed when the display read operation completion feedback signal 532 transforms from low to high level. At time point t98, when the display read operation completion feedback signal 532 transforms from high to low level, since two read operations have been performed, the command sequencer 51 clears the previously recorded memory read state so that the memory read state signal 512 is pulled down to a low level, and the arbitration circuit 52 performs a reset operation to set the memory write signal 521 and the memory read signal 522 to a low level. Next, whether there is still other command to be executed is determined at a negative edge of the judgement signal 561. Since the memory write state signal 511 is at a high level and the memory read state signal 512 is at a low level, the write operation is then performed as described in foregoing embodiment.

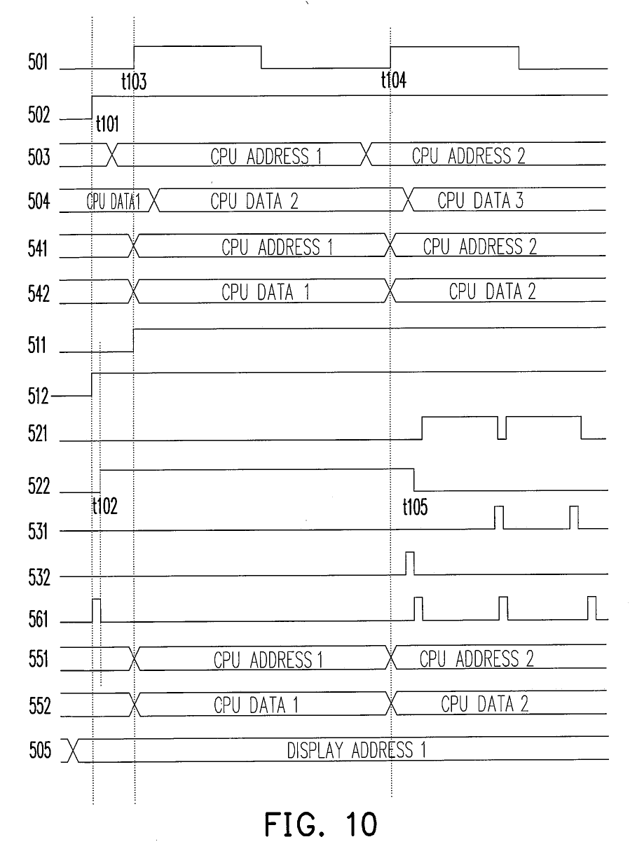

FIG. 10 is a timing diagram illustrating the relationship between operation time allocated to read operation and the CPU write cycle regarding the asynchronous memory illustrated in FIG. 5.

When the display read command 502 and the CPU write command 501 happen closely with the display read command 502 prior to the CPU write command 501 (referring to the CPU write command 501 and the display read command 502 at time points t103 and t101 in FIG. 10), the display read command 502 is first executed (referring to the memory read signal 522 at time point t102 in FIG. 10). Referring to FIG. 5 again, the register 54 is designed to have only one layer; namely, the register 54 can only store one CPU write data and address. Accordingly, the time spent for executing the display read command 502 cannot exceed one cycle of the CPU write operation, namely, in FIG. 10, the interval between time points t102 and t105 cannot be longer than the interval between time points t103 and t104. If the CPU write command 501 is executed only when the operation time of the display read command 502 exceeds one cycle of the CPU write operation, the first CPU write address signal 503 and CPU write data signal 504 stored in the register 54 may be overwritten by the second CPU write address signal 503 and the CPU write data signal 504. As described above, in the present invention, the time spent for executing the display read operation is equal to the product of the number of layers of the register 54 and a cycle of the CPU write operation.

In summary, the present invention provides a memory data access method, wherein through an arbitration and feedback circuit, a CPU write command and a display read command are directly input to a memory and are executed in an appropriate order so as to optimize the operation time. In particular, as shown in foregoing embodiments, the operation time for accessing a memory can be optimized so that the efficiency thereof can be greatly improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A memory data access method, comprising:
inputting a central processing unit (CPU) write command and a display read command into a memory, and reading data from the memory and transmitting the data to a display unit;
performing a write operation on the memory by executing the write command; and
performing a read operation on the memory by executing the read command during spare time of the write operation.

2. The memory data access method according to claim 1 further comprising an arbitration circuit for determining that the write command is prior to the read command.

3. The memory data access method according to claim 1 further comprising dividing the read operation in order to insert the read operation into the spare time of the write operation appropriately.

4. The memory data access method according to claim 1, wherein the display unit is a liquid crystal display (LCD) panel.

5. The memory data access method according to claim 1, wherein the write command is a voltage signal.

6. The memory data access method according to claim 1, wherein the read command is a voltage signal.

7. The memory data access method according to claim 1, wherein the memory is an asynchronous memory.

8. A memory, comprising:
an arbitration circuit, wherein when the arbitration circuit receives a CPU write command and a display read command, a write operation is first performed on the memory by executing the write command, and then the memory performs one or a plurality of read operations on the memory by executing the read command during spare time of the write operation.

9. The memory according to claim 8, wherein the read operation is divided to be inserted into the spare time of the write operation appropriately.

10. The memory according to claim 8, wherein the display unit is a LCD panel.

11. The memory according to claim 8, wherein the write command is a voltage signal.

12. The memory according to claim 8, wherein the read command is a voltage signal.

13. The memory according to claim 8, wherein the memory is an asynchronous memory.
